(19) United States
(12) Patent Application Publication
(10) Pub. No.: US 2008/0146229 A1
(43) Pub. Date: Jun. 19, 2008

(54) Method and Apparatus to Facilitate Maintaining a Substantially Uninterrupted Internet Protocol Data Session Portion of a Handed-Off Call Session

(75) Inventors: Chandra Warrier, Schaumburg, IL (US); Quan Choi, Port Barrington, IL (US)

Correspondence Address: UTSTARCOM, INC. / FETF, 120 S. LASALLE STREET, SUITE 1600, CHICAGO, IL, 60603-3406, US

(73) Assignee: UTSTARCOM, INC., Alameda, CA (US)

(21) Appl. No.: 11/610,677

(22) Filed: Dec. 14, 2006

(51) Int. Cl. H04Q 7/20

(52) U.S. Cl. 455/436

(57) ABSTRACT

One detects (101) (for example, via a wireless control node (600)) the handing off of a call session for a mobile station from either a CDMA wireless environment to an 802.16(e)-compatible wireless environment or vice versa. In either case, one then maintains (102) a substantially uninterrupted Internet Protocol data session portion of that call session notwithstanding the handing off of the call session for the mobile station.

### TECHNICAL FIELD

This invention relates generally to the handing off of call sessions and more particularly to the handing off of a call session for a mobile station between CDMA wireless environments and 802.16(e)-compatible wireless environments.

### BACKGROUND

Various approaches to wireless communications are known in the art. In some cases, such as with a typical cellular telephony communication system, the system will permit the handing off of an ongoing call session from one base station to another for a given mobile station as that mobile station moves from one coverage area as corresponds to one base station to another. In general, such hand offs occur relatively transparently and without substantial interruption to the user. As a result, for example, the user can continue a voice communication without noticing that their communication platform has switched from one base station to another.

As the number of available wireless communication options grows, multi-mode mobile stations have been proposed. This includes, for example, mobile stations that are capable of compatibly operating in either of a CDMA wireless environment (such as, but not limited to, a CDMA 2000 network) and an 802.16(e)-compatible network (also sometimes referred to as a WiMAX network). Though such environments are not intrinsically compatible with one another, proposals nevertheless exist to permit a call session for a given mobile station to be handed off from one such wireless environment to another. This can permit, for example, a given user to have the opportunity to possibly better control their operating costs and/or bandwidth usage by preferring a particular wireless environment when available though still remaining operable in at least one other wireless environment when the preferred environment is unavailable.

Present proposals tend to emphasize handing off the bearer channel as supports such a call session. Such emphasis can be suitable for some applications but not for all. As one example in this regard, present proposals will tend to ruthlessly terminate an ongoing Internet Protocol data session portion of a call session that is handed off from a CDMA wireless environment to an 802.16(e)-compatible wireless environment or vice versa. This, in turn, can inconvenience the user and lead to dissatisfaction and frustration with their services.

### BRIEF DESCRIPTION OF THE DRAWINGS

The above needs are at least partially met through provision of the method and apparatus to facilitate maintaining a substantially uninterrupted internet protocol data session portion of a handed-off call session described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a call flow diagram as configured in accordance with various embodiments of the invention;

FIG. 4 comprises a flow diagram as configured in accordance with various embodiments of the invention;

FIG. 5 comprises a call flow diagram as configured in accordance with various embodiments of the invention; and

FIG. 6 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one detects the handing off of a call session for a mobile station from either a CDMA wireless environment to an 802.16(e)-compatible wireless environment or vice versa. In either case, one then maintains (using, for example, a wireless control node) a substantially uninterrupted Internet Protocol data session portion of that call session notwithstanding the handing off of the call session for the mobile session.

The particulars of such maintenance can vary, for example, with respect to the direction of the hand off. For example, when handing off the call session from the CDMA wireless environment to the 802.16(e)-compatible wireless environment, the aforementioned wireless control node can receive information from the 802.16(e)-compatible wireless environment regarding a presence of the mobile station in the 802.16(e)-compatible wireless environment and then use that information to identify the mobile station as having an existing session relationship with the serving gateway that is supporting the Internet Protocol data session and to instruct that serving gateway to establish a data path with the 802.16(e)-compatible wireless environment such that the Internet Protocol data session portion of the call session is maintained without substantial interruption.

Similarly, when handing off the call session from the 802.16(e)-compatible wireless environment to the CDMA wireless environment, the aforementioned wireless control node can receive information from the CDMA wireless environment regarding a presence of the mobile station in the CDMA wireless environment and then redirect the CDMA wireless environment to the aforementioned serving gateway such that the serving gateway can establish a suitable communication path with the CDMA wireless environment to thereby permit the Internet Protocol data session portion of the handed off call session to be maintained without substantial interruption.

By one approach, in either or both such cases, a same Internet Protocol address as was used by the serving gateway to support the Internet Protocol data session portion of the call session prior to the hand off can continue to serve in this same capacity. This, in turn, can further assist with facilitating the maintenance of the Internet Protocol data session portion of the call session without substantial interruption notwithstanding the hand off event from one wireless environment to another.

So configured, those skilled in the art will recognize and appreciate that these teachings permit an ongoing call session that includes an Internet Protocol data session to be handed off from one wireless environment to another without substantial interruption notwithstanding that such wireless environments may be largely or fully operationally incompatible with one another. The disclosed ability to effectively facilitate, mediate, and direct a handing off of the serving gateway's activities between such wireless environments comprises a highly leverageable, cost efficient approach to providing such a capability. Those skilled in the art will further recognize that these teachings are readily scaled and will serve well in a wide variety of application settings.

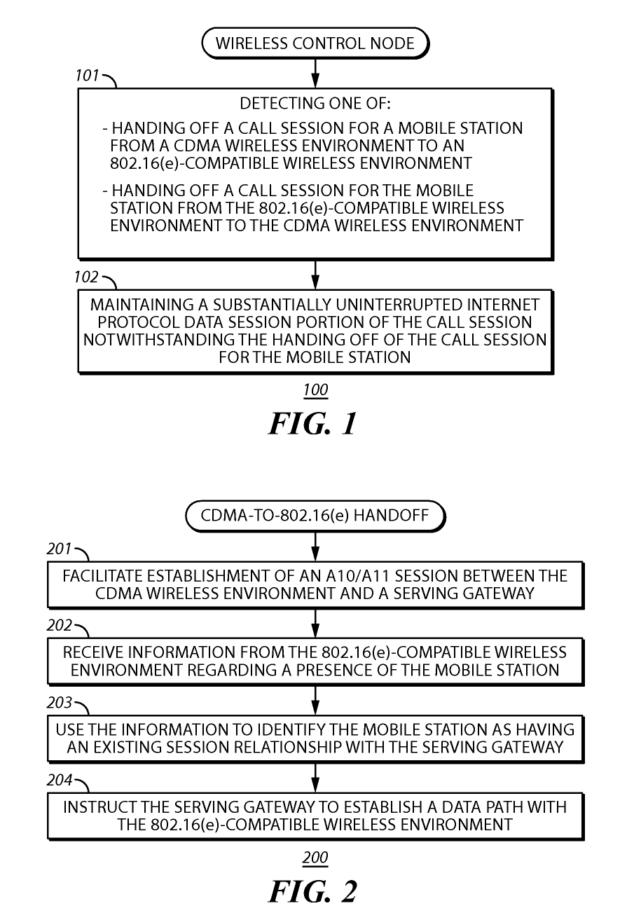

These and other benefits may become clearer upon making a thorough review and study of the following detailed description. Referring now to the drawings, and in particular to FIG. 1, a process 100 that can be carried out by, for example, a wireless control node will be described. This process 100 provides first for detecting 101 a hand off of a call session for a given mobile station. In particular, in this illustrative example, this can comprise either of a hand off from a CDMA wireless environment to an 802.16(e)-compatible wireless environment or a hand off from the 802.16(e)-compatible wireless environment to the CDMA wireless environment. (Those skilled in the art will recognize that such wireless environments are well understood in the art and require no further description here. It will also be understood that there are various ways by which such a hand off can be handed off and/or detected that are presently known with other approaches likely to be developed in the future. As the present teachings are not particularly sensitive to the selection of any particular approach in this regard, for the sake of brevity further elaboration will not be presented here in this regard.)

This process 100 then provides for maintaining 102 a substantially uninterrupted Internet Protocol data session portion of the call session notwithstanding the handing off of the call session for the mobile station. The particular approach utilized to effect such maintenance can vary, if desired, with respect to the direction of the hand off.

To illustrate, and referring now to FIG. 2, when the hand off comprises a hand off of the call session from a CDMA wireless environment to a 802.16(e)-compatible wireless environment, a corresponding process 200 can provide, typically prior to the hand off event, for facilitating establishment of the Internet Protocol data session portion of the call session in the CDMA wireless environment by facilitating establishment 201, via the aforementioned wireless control node, of an A10/A11 session between the CDMA wireless environment and the aforementioned serving gateway. (A10/A11 sessions are well understood in the art and require no further discussion here.) This can include storing information about the session relationship between the mobile station and this serving gateway (using, for example, a locally or remotely accessible database resource or the like).

In response to detection of the hand off event, this process 200 can then provide for receiving 202 information from the 802.16(e)-compatible wireless environment regarding the presence of the mobile station in the 802.16(e)-compatible wireless environment (as a result, of course, of the hand off event itself). This received information may comprise, for example, information that uniquely identifies the mobile station (such as, but not limited to, Network Access Identifier (NAI) information, an assigned telephone number, and so forth). This information is then used 203 (for example, by using the information that uniquely identifies the mobile station to query a database to correlate the mobile station with the serving gateway) to identify the mobile station as having an existing session relationship with the serving gateway.

The wireless control node can then instruct 204 the serving gateway to establish a data path with the 802.16(e)-compatible wireless environment such that the Internet Protocol data session portion of the call session is maintained without substantial interruption and while continuing to use a same Internet Protocol address as was previously used by the serving gateway to support the Internet Protocol data session portion of the call session in the CDMA wireless environment for this mobile station.

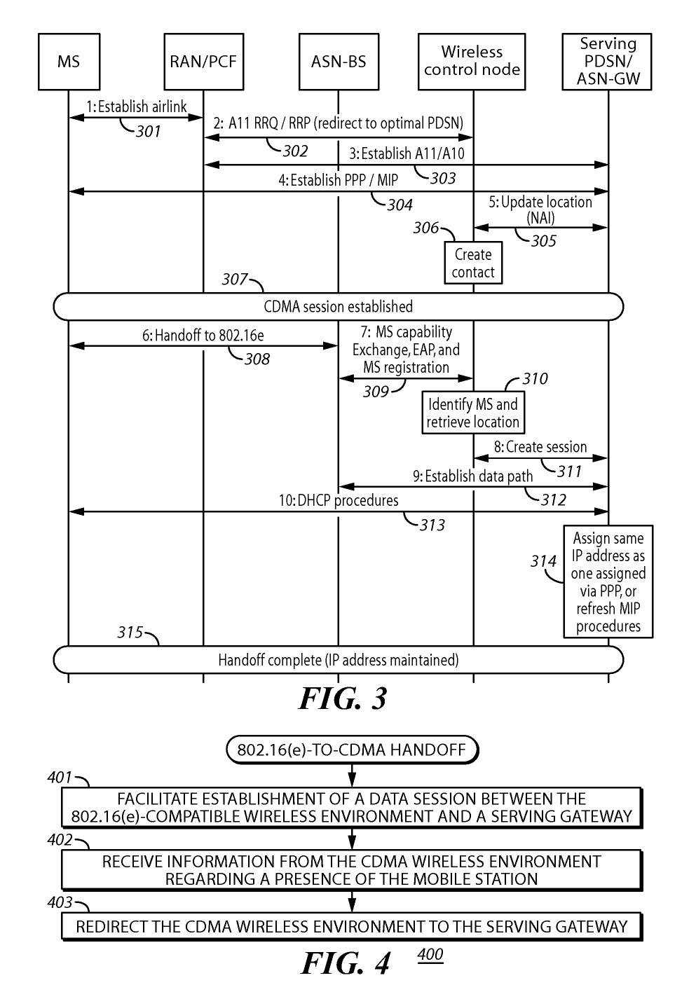

To further illustrate such an approach, and referring now to FIG. 3, a more particular example in this regard will be provided. Those skilled in the art will understand that the particulars of this example are intended to serve only in an illustrative capacity and are not intended as specific limitations with respect to the scope and applicability of these teachings.

In this example, a mobile station (MS) establishes a CDMA airlink 301 with the radio access network/packet control function (RAN/PCF) of the CDMA wireless environment in accordance with known practice. The RAN/PCF then conducts an A11 RRQ/RRP request/response exchange 302 with a wireless control node that has been configured and arranged to accord with the teachings set forth herein. In this example, the wireless control node's response includes an optimal packet data serving node (PDSN) address that comprises the address for the serving gateway that will facilitate needed Internet Protocol data session activity for the mobile station. Using this information, the RAN/PCF establishes an A11/A10 session 303 with the serving gateway followed by establishment of Point-to-Point Protocol (PPP)/Mobile Internet Protocol (MIP) procedures 304 (presuming this mobile station to be capable, of course, of MIP) with the serving gateway.

This latter session 303 can include the serving gateway obtaining an Internet Protocol address for the benefit of the mobile station. This can comprise, for example, the serving gateway assigning such an address to the mobile station. As another example, this can comprise the serving gateway cooperating with a corresponding home agent for the mobile station that, in turn, assigns such an Internet Protocol address. This, of course, establishes an Internet Protocol data session in service of the mobile station via the CDMA wireless environment.

In this illustrative example the serving gateway now conducts an exchange 305 with the wireless control node to update the latter with respect to the location of the mobile station (i.e., the now-established relationship between the serving gateway and the mobile station). This update can include information that specifically identifies the mobile station in this regard (such as, in this example, NAI information for the mobile station). The wireless control node then uses this information to create a context 306 for the mobile station.

At this point, the CDMA session 307 for the mobile station is now well established. Eventually, however, in this example, the call session is handed off 308 to an 802.16(e)-compatible wireless environment. This, of course, leads to the establishment of a session between the mobile station and an Access Service Network-base station (ASN-BS) for the 802.16(e)-compatible wireless environment as understood in the art.

In this example, the ASN-BS now conducts an exchange 309 with the wireless control node to perform mobile station capability exchange, extensible authorization protocol (EAP) procedures, and mobile station registration. The wireless control node responds, in this example, by extracting the NAI information from the EAP message(s) and using this information to compare against its previously stored information to thereby identify 310 the mobile station and its location vis-à-vis the serving gateway. The wireless control node then uses those results to instruct 311 the serving gateway to create a data path. Such instructions might be presented using, for example, R4 messaging techniques.

The serving node then establishes a data path 312 with the ASN-BS following which the mobile station and the serving gateway are able to perform Dynamic Host Configuration Protocol (DHCP) procedures 313 (or, for example, Mobile Internet Protocol (MIP) procedures). This can comprise, by one approach, the serving gateway assigning 314 a same Internet Protocol address was previously used during the above-described PPP/MIP procedures for the CDMA session for the 802.16(e)-compatible wireless environment session. The hand off completed 315, the mobile station's Internet Protocol data session portion of the handed off call session remains intact, without substantial interruption, and with the original Internet Protocol address remaining in use.

Referring now to FIG. 4, a description of a process 400 to facilitate a similar result when the hand off comprises a hand off from an 802.16(e)-compatible wireless environment to a CDMA wireless environment will be described. This can again comprise, prior to the hand off event, facilitating the establishment of an Internet Protocol data session for the mobile station in the first instance by facilitating the establishment 401 of a data session between the 802.16(e)-compatible wireless environment and a corresponding serving gateway.

As and when a hand off event occurs, this process 400 then provides for receiving 402 information from the CDMA wireless environment regarding a presence of the mobile station in the CDMA wireless environment and then redirecting 403 the CDMA wireless environment to the serving gateway such that the serving gateway can establish, for example, an A10/A11 session with the CDMA wireless environment such that the Internet Protocol data session portion of the call session is again maintained without substantial interruption while continuing, if desired, to use a same Internet Protocol address as was used previously used by the serving gateway to support the Internet Protocol data session portion of the handed off call session in the 802.16(e)-compatible wireless environment for this mobile station.

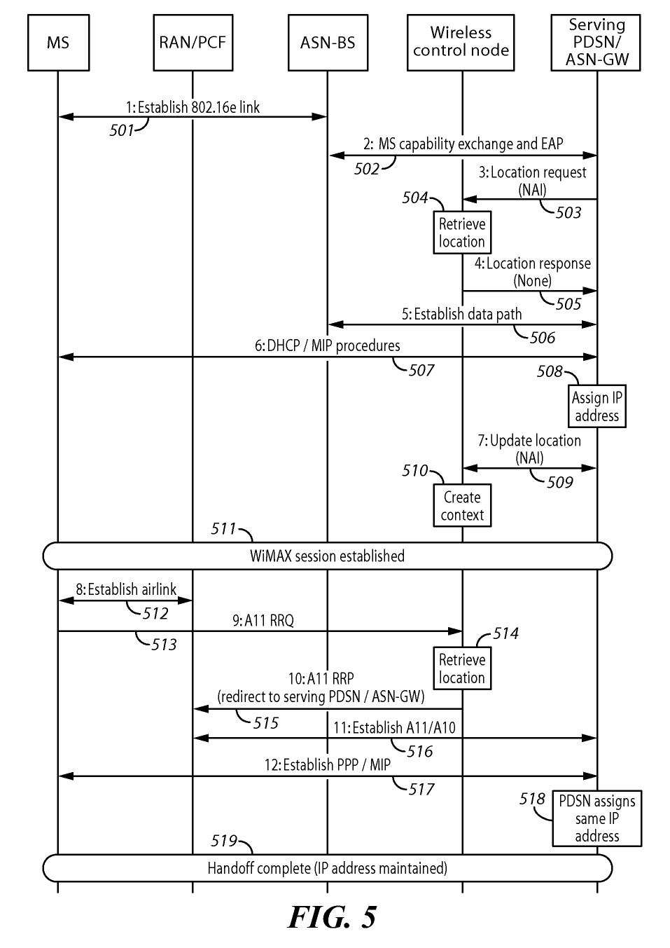

To further illustrate such an approach, and referring now to FIG. 5, a more particular example in this regard will be provided. Those skilled in the art will again understand that the particulars of this example are intended to serve only in an illustrative capacity and are not intended as specific limitations with respect to the scope and applicability of these teachings.

In this example, where the mobile station begins in an 802.16(e)-compatible wireless environment, the mobile station first connects to the latter and establishes a corresponding 802.16(e) session 501 with the ASN-BS for that environment. The ASN-BS then selects a serving gateway and performs a mobile station capability exchange and EAP procedures 502. The serving gateway extracts identifying information as corresponds to the mobile station (in this example, NAI information for the mobile station) and transmits a location request 503 to the wireless control node that includes the unique mobile station identifier. The wireless control node queries its stored information 504 and determines, in this case, that no context exists for the mobile station at this time. This leads to providing a location response message 505 to the serving gateway indicating this status.

In response, the serving gateway establishes a data path 506 with the ASN-BS following which the mobile station conducts DHCP/MIP procedures 507 with the serving gateway using an Internet Protocol address that is assigned 508, for example, by the serving gateway or a home agent for the mobile station with which the serving gateway cooperates. The serving gateway now transmits an update message 509 to the wireless control node to update the latter's location information. This message 509 can include identifying information for the mobile station such as the aforementioned NAI information. The wireless control node then creates a context 510 for the mobile station and updates its records accordingly.

The 802.16(e)-compatible wireless environment session is now established inclusive of an Internet Protocol data session portion.

As a hand off occurs from the 802.16(e)-compatible wireless environment to the CDMA wireless environment, the mobile station establishes its air link 512 with the RAN/PCF for the CDMA wireless environment. The PCF then responsively transmits an A11 request 513 to the wireless control node which retrieves 514 the location information for the mobile station as relates to the mobile stations established relationship with the serving gateway and then transmits an A11 response message 515 to redirect the PCF to the serving gateway.

The PCF then establishes an A11/A10 session 516 with the serving gateway which thereby facilitates the mobile station establishing a PPP/MIP session 517 with the serving gateway. In this example, the serving gateway assigns 518 the same Internet Protocol address as was earlier used by the mobile station in the 802.16(e)-compatible wireless environment. So conducted, the hand off completes 519 with the Internet Protocol data session intact and substantially uninterrupted and with, in this example, the same Internet Address persisting throughout the process.

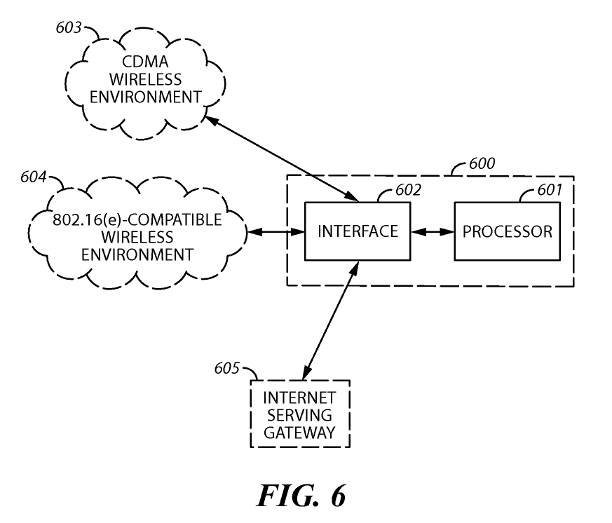

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 6, an illustrative approach to such a platform will now be provided.

A corresponding wireless control node 600 can be comprised, generally speaking, of a processor 601 that operably couples to an interface 602. The interface 602 can be configured and arranged in accordance with well-established practice in this regard to operably couple to each of a CDMA wireless environment 603, an 802.16(e)-compatible wireless environment 604, and an Internet serving gateway 605, all as have been generally referred to above.

The processor 601 may comprise a partially or fully programmable platform, if desired, that is configured and arranged (using, for example, programming techniques as will be well understood by those in the art) to facilitate selected teachings as are contained herein. This can comprise, in particular, detecting the hand off of an existing mobile station call session that includes an Internet Protocol data session portion from one wireless environment to another. Such programming can specifically include, as desired, any of the previously described functionality.

If desired, the processor 601 can itself comprise integral memory that can serve to store the aforementioned location/context information. In the alternative, if desired, separate local and/or remotely located memory resources (not shown) can be provided for this purpose.

Those skilled in the art will recognize and understand that such an apparatus 600 may be comprised of a plurality of physically distinct elements as is suggested by the illustration shown in FIG. 6. It is also possible, however, to view this illustration as comprising a logical view, in which case one or more of these elements can be enabled and realized via a shared platform. It will also be understood that this wireless control node 600 can comprise a standalone discrete network element if desired or can comprise a part of one or more other elements. Decisions in this regard will typically depend upon the needs, limitations, and/or opportunities afforded by a particular application setting.

So configured, those skilled in the art will recognize and appreciate that these teachings offer a flexible, yet highly leveraged approach to ensuring that Internet data sessions are not unduly interrupted by necessary or convenient hand offs between non-compatible wireless technologies such as CDMA and 802.16(e)-compatible wireless environments. These teachings are readily scaled and can be implemented without requiring reprogramming or alteration of already-fielded mobile stations. These teachings are readily implemented in a cost effective manner.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
detecting one of:
handing off a call session for a mobile station from a CDMA wireless environment to an 802.16(e)-compatible wireless environment;
handing off a call session for the mobile station from the 802.16(e)-compatible wireless environment to the CDMA wireless environment;
maintaining a substantially uninterrupted Internet Protocol data session portion of the call session notwithstanding the handing off of the call session for the mobile station.

2. The method of claim 1 wherein, when detecting comprises detecting handing off a call session for a mobile station from a CDMA wireless environment to an 802.16(e)-compatible wireless environment, maintaining a substantially uninterrupted Internet Protocol data session portion of the call session notwithstanding the handing off of the call session for the mobile station comprises, at least in part, establishing the Internet Protocol data session portion of the call session in the CDMA wireless environment using a wireless control node element to facilitate establishment of an A10/A11 session between the CDMA wireless environment and a serving gateway.

3. The method of claim 2 wherein maintaining a substantially uninterrupted Internet Protocol data session portion of the call session notwithstanding the handing off of the call session for the mobile station further comprises, at least in part, establishing the Internet Protocol data session portion of the call session in the 802.16(e)-compatible wireless environment using the wireless control node element to facilitate establishment of a data path between the 802.16(e)-compatible wireless environment and the serving gateway.

4. The method of claim 3 wherein establishing the Internet Protocol data session portion of the call session in the 802.16(e)-compatible wireless environment using the wireless control node element to facilitate establishment of a data path between the 802.16(e)-compatible wireless environment and the serving gateway comprises, at least in part:
at the wireless control node element:
receiving information from the 802.16(e)-compatible wireless environment regarding a presence of the mobile station in the 802.16(e)-compatible wireless environment;
using the information to identify the mobile station as having an existing session relationship with the serving gateway;
instructing the serving gateway to establish a data path with the 802.16(e)-compatible wireless environment such that the Internet Protocol data session portion of the call session is maintained without substantial interruption while continuing to use a same Internet Protocol address as was previously used by the serving gateway to support the Internet Protocol data session portion of the call session in the CDMA wireless environment for this mobile station.

5. The method of claim 4 wherein using the information to identify the mobile station as having an existing session relationship with the serving gateway comprises, at least in part, using the information to uniquely identify the mobile station.

6. The method of claim 5 wherein using the information to identify the mobile station as having an existing session relationship with the serving gateway comprises, at least in part, querying a database to correlate the mobile station with the serving gateway.

7. The method of claim 1 wherein, when detecting comprises handing off a call session for the mobile station from the 802.16(e)-compatible wireless environment to the CDMA wireless environment, maintaining a substantially uninterrupted Internet Protocol data session portion of the call session notwithstanding the handing off of the call session for the mobile station comprises, at least in part, establishing the Internet Protocol data session portion of the call session in the 802.16(e)-compatible wireless environment using a wireless control node element to facilitate establishment of a data session between the 802.16(e)-compatible wireless environment and a serving gateway.

8. The method of claim 7 wherein maintaining a substantially uninterrupted Internet Protocol data session portion of the call session notwithstanding the handing off of the call session for the mobile station further comprises, at least in part, establishing the Internet Protocol data session portion of the call session in the CDMA wireless environment using the wireless control node element to facilitate establishment of an A10A11 session between the CDMA wireless environment and the serving gateway.

9. The method of claim 8 wherein establishing the Internet Protocol data session portion of the call session in the CDMA wireless environment using the wireless control node element to facilitate establishment of an A10/A11 session between the CDMA wireless environment and the serving gateway comprises, at least in part:
at the wireless control node element:
receiving information from the CDMA wireless environment regarding a presence of the mobile station in the CDMA wireless environment;
redirecting the CDMA wireless environment to the serving gateway such that the serving gateway can establish the A10/A11 session with the CDMA wireless environment such that the Internet Protocol data session portion of the call session is maintained without substantial interruption while continuing to use a same Internet Protocol address as was previously used by the serving gateway to support the Internet Protocol data session portion of the call session in the 802.16(e)-compatible wireless environment for this mobile station.

10. The method of claim 9 wherein redirecting the CDMA wireless environment to the serving gateway comprises, at least in part, using the information to uniquely identify the mobile station.

11. The method of claim 10 wherein redirecting the CDMA wireless environment to the serving gateway comprises, at least in part, querying a database to correlate the mobile station with the serving gateway.

12. An apparatus comprising:
means for detecting one of:
handing off a call session for a mobile station from a CDMA wireless environment to an 802.16(e)-compatible wireless environment;
handing off a call session for the mobile station from the 802.16(e)-compatible wireless environment to the CDMA wireless environment;
means responsive to the means for detecting for maintaining a substantially uninterrupted Internet Protocol data session portion of the call session notwithstanding the handing off of the call session for the mobile station.

13. The apparatus of claim 12 wherein, when the means for detecting comprises means for detecting handing off a call session for a mobile station from a CDMA wireless environment to an 802.16(e)-compatible wireless environment, the means for maintaining a substantially uninterrupted Internet Protocol data session portion of the call session notwithstanding the handing off of the call session for the mobile station comprises, at least in part, means for establishing the Internet Protocol data session portion of the call session in the CDMA wireless environment using a wireless control node element to facilitate establishment of an A10/A11 session between the CDMA wireless environment and a serving gateway.

14. The apparatus of claim 13 wherein the means for maintaining a substantially uninterrupted Internet Protocol data session portion of the call session notwithstanding the handing off of the call session for the mobile station further comprises, at least in part, means for establishing the Internet Protocol data session portion of the call session in the 802.16(e)-compatible wireless environment using the wireless control node element to facilitate establishment of a data path between the 802.16(e)-compatible wireless environment and the serving gateway.

15. The apparatus of claim 14 wherein the means for establishing the Internet Protocol data session portion of the call session in the 802.16(e)-compatible wireless environment using the wireless control node element to facilitate establishment of a data path between the 802.16(e)-compatible wireless environment and the serving gateway comprises, at least in part:
at the wireless control node element:
means for receiving information from the 802.16(e)-compatible wireless environment regarding a presence of the mobile station in the 802.16(e)-compatible wireless environment;
means for using the information to identify the mobile station as having an existing session relationship with the serving gateway;
means for instructing the serving gateway to establish a data path with the 802.16(e)-compatible wireless environment such that the Internet Protocol data session portion of the call session is maintained without substantial interruption while continuing to use a same Internet Protocol address as was previously used by the serving gateway to support the Internet Protocol data session portion of the call session in the CDMA wireless environment for this mobile station.

16. The apparatus of claim 15 wherein the means for using the information to identify the mobile station as having an existing session relationship with the serving gateway comprises, at least in part, means for using the information to uniquely identify the mobile station.

17. The apparatus of claim 16 wherein the means for using the information to identify the mobile station as having an existing session relationship with the serving gateway comprises, at least in part, means for querying a database to correlate the mobile station with the serving gateway.

18. The apparatus of claim 12 wherein, when the means for detecting comprises means for detecting the handing off a call session for the mobile station from the 802.16(e)-compatible wireless environment to the CDMA wireless environment, the means for maintaining a substantially uninterrupted Internet Protocol data session portion of the call session notwithstanding the handing off of the call session for the mobile station comprises, at least in part, means for establishing the Internet Protocol data session portion of the call session in the 802.16(e)-compatible wireless environment using a wireless control node element to facilitate establishment of a data session between the 802.16(e)-compatible wireless environment and a serving gateway.

19. The apparatus of claim 18 wherein the means for maintaining a substantially uninterrupted Internet Protocol data session portion of the call session notwithstanding the handing off of the call session for the mobile station further comprises, at least in part, means for establishing the Internet Protocol data session portion of the call session in the CDMA wireless environment using the wireless control node element to facilitate establishment of an A10/A11 session between the CDMA wireless environment and the serving gateway.

20. The apparatus of claim 19 wherein the means for establishing the Internet Protocol data session portion of the call session in the CDMA wireless environment using the wireless control node element to facilitate establishment of an A10/A11 session between the CDMA wireless environment and the serving gateway comprises, at least in part:
at the wireless control node element:
means for receiving information from the CDMA wireless environment regarding a presence of the mobile station in the CDMA wireless environment;
means for redirecting the CDMA wireless environment to the serving gateway such that the serving gateway can establish the A10/A11 session with the CDMA wireless environment such that the Internet Protocol data session portion of the call session is maintained without substantial interruption while continuing to use a same Internet Protocol address as was previously used by the serving gateway to support the Internet Protocol data session portion of the call session in the 802.16(e)-compatible wireless environment for this mobile station.

21. The apparatus of claim 20 wherein the means for redirecting the CDMA wireless environment to the serving gateway comprises, at least in part, means for using the information to uniquely identify the mobile station.

22. The apparatus of claim 21 wherein the means for redirecting the CDMA wireless environment to the serving gateway comprises, at least in part, means for querying a database to correlate the mobile station with the serving gateway.

23. A wireless control node comprising:
an interface operably coupled to each of a CDMA wireless environment, an 802.16(e)-compatible wireless environment, and an Internet serving gateway;
a processor operably coupled to the interface and being configured and arranged to:
detect one of:
handing off a call session for a mobile station from a CDMA wireless environment to an 802.16(e)-compatible wireless environment;
handing off a call session for the mobile station from the 802.16(e)-compatible wireless environment to the CDMA wireless environment;
maintain a substantially uninterrupted Internet Protocol data session portion of the call session notwithstanding the handing off of the call session for the mobile station.

24. The wireless control node of claim 23 wherein, when the processor is configured and arranged to detect handing off a call session for a mobile station from a CDMA wireless environment to an 802.16(e)-compatible wireless environment, the processor is configured and arranged to maintain a substantially uninterrupted Internet Protocol data session portion of the call session notwithstanding the handing off of the call session for the mobile station by, at least in part, establishing the Internet Protocol data session portion of the call session in the CDMA wireless environment using a wireless control node element to facilitate establishment of an A10/A11 session between the CDMA wireless environment and a serving gateway.

25. The wireless control node of claim 24 wherein the processor is further configured and arranged to maintain a substantially uninterrupted Internet Protocol data session portion of the call session notwithstanding the handing off of the call session for the mobile station by, at least in part, establishing the Internet Protocol data session portion of the call session in the 802.16(e)-compatible wireless environment using the wireless control node element to facilitate establishment of a data path between the 802.16(e)-compatible wireless environment and the serving gateway.

26. The wireless control node of claim 25 wherein the processor is further configured and arranged to establish the Internet Protocol data session portion of the call session in the 802.16(e)-compatible wireless environment using the wireless control node element to facilitate establishment of a data path between the 802.16(e)-compatible wireless environment and the serving gateway by, at least in part:
receiving information from the 802.16(e)-compatible wireless environment regarding a presence of the mobile station in the 802.16(e)-compatible wireless environment;
using the information to identify the mobile station as having an existing session relationship with the serving gateway;
instructing the serving gateway to establish a data path with the 802.16(e)-compatible wireless environment such that the Internet Protocol data session portion of the call session is maintained without substantial interruption while continuing to use a same Internet Protocol address as was previously used by the serving gateway to support the Internet Protocol data session portion of the call session in the CDMA wireless environment for this mobile station.

27. The wireless control node of claim 26 wherein the processor is further configured and arranged to use the information to identify the mobile station as having an existing session relationship with the serving gateway by, at least in part, using the information to uniquely identify the mobile station.

28. The wireless control node of claim 27 wherein the processor is further configured and arranged to use the information to identify the mobile station as having an existing session relationship with the serving gateway by, at least in part, querying a database to correlate the mobile station with the serving gateway.

29. The wireless control node of claim 23 wherein, when the processor is configured and arranged to detect handing off a call session for the mobile station from the 802.16(e)-compatible wireless environment to the CDMA wireless environment, the processor is further configured and arranged to maintain a substantially uninterrupted Internet Protocol data session portion of the call session notwithstanding the handing off of the call session for the mobile station by, at least in part, establishing the Internet Protocol data session portion of the call session in the 802.16(e)-compatible wireless environment using a wireless control node element to facilitate establishment of a data session between the 802.16(e)-compatible wireless environment and a serving gateway.

30. The wireless control node of claim 29 wherein the processor is further configured and arranged to maintain a substantially uninterrupted Internet Protocol data session portion of the call session notwithstanding the handing off of the call session for the mobile station by, at least in part, establishing the Internet Protocol data session portion of the call session in the CDMA wireless environment using the wireless control node element to facilitate establishment of an A10/A11 session between the CDMA wireless environment and the serving gateway.

31. The wireless control node of claim 30 wherein the processor is further configured and arranged to establish the Internet Protocol data session portion of the call session in the CDMA wireless environment using the wireless control node element to facilitate establishment of an A10/A11 session between the CDMA wireless environment and the serving gateway by, at least in part:
receiving information from the CDMA wireless environment regarding a presence of the mobile station in the CDMA wireless environment;
redirecting the CDMA wireless environment to the serving gateway such that the serving gateway can establish the A10/A11 session with the CDMA wireless environment such that the Internet Protocol data session portion of the call session is maintained without substantial interruption while continuing to use a same Internet Protocol address as was previously used by the serving gateway to support the Internet Protocol data session portion of the call session in the 802.16(e)-compatible wireless environment for this mobile station.

32. The wireless control node of claim 31 wherein the processor is further configured and arranged to redirect the CDMA wireless environment to the serving gateway by, at least in part, using the information to uniquely identify the mobile station.

33. The wireless control node of claim 32 wherein the processor is further configured and arranged to redirect the CDMA wireless environment to the serving gateway by, at least in part, querying a database to correlate the mobile station with the serving gateway.
